(19) United States
(12) Patent Application Publication
(10) Pub. No.: US 2006/0026628 A1
(43) Pub. Date: Feb. 2, 2006

(54) Method and apparatus for insertion of additional content into video

(76) Inventors: Kong Wah Wan, Singapore (SG); Chang Sheng Xu, Singapore (SG); Joo Hwee Lim, Singapore (SG); Xin Guo Yu, Singapore (SG)

Correspondence Address: Hugh R. Kress;Browning Bushman P.C., Suite 1800, 5718 Westheimer, Houston, TX, 77057, US

(21) Appl. No.: 11/192,590

(22) Filed: Jul. 29, 2005

(30) Foreign Application Priority Data
Jul. 30, 2004 (SG) 200404282-6

(51) Int. Cl. H04N 7/10; H04N 7/12

(52) U.S. Cl. 725/32; 375/240.26

(57) ABSTRACT

A method and apparatus inserts virtual advertisements or other virtual contents into a sequence of frames of a video presentation by performing real-time content-based video frame processing to identify suitable locations in the video for implantation. Such locations correspond to both the temporal segments within the video presentation and the regions within an image frame that are commonly considered to be of lesser relevance to the viewers of the video presentation. This invention presents a method and apparatus that allows a non-intrusive means to incorporate additional virtual content into a video presentation, facilitating an additional channel of communications to enhance greater video interactivity.

### FIELD OF THE INVENTION

The present invention relates to the use of video and, in particular, to the insertion of extra or additional content into video.

### BACKGROUND

The field of multimedia communications has seen tremendous growth over the past decade, leading to vast improvements that allow real-time computer-aided digital effects to be introduced into video presentations. For example, methods have been developed for the purpose of inserting advertising image/video overlays into selected frames of a video broadcast. The inserted advertisements are implanted in a perspective-preserving manner that appears to be part of the original video scene to a viewer.

A typical application for such inserted advertisements is seen in the broadcast videos of sporting events. Because such events are often played at a stadium, which is a known and predictable playing environment, there will be known regions in the viewable background of a camera view that is capturing the event from a fixed position. Such regions include advertising hoardings, terraces, spectator stands, etc.

Semi-automated systems exist which make use of the above fact to determine information to implant advertisements into selected background regions of the video. This may be provided via a perspective-preserving mapping of the physical ground model to the video image co-ordinates. Advertisers then buy space in a video to insert their advertisements into the selected image regions. Alternatively, one or more authoring stations are used to interact with the video feed manually to designate image regions useful for virtual advertisements.

U.S. Pat. No. 5,808,695, issued on 15 Sep. 1998 to Rosser et al. and entitled “Method of Tracking Scene Motion for Live Video Insertion Systems”, describes a method for tracking motion from image field to image field in a sequence of broadcast video images, for the purpose of inserting indicia. Static regions in the arena are manually defined and, over the video presentation, these are tracked to maintain their corresponding image co-ordinates for realistic insertion. Intensive manual calibration is needed to identify these target regions as they need to be visually differentiable so as to facilitate motion tracking. There is also no way to allow the insertion to be occluded by moving images from the original video content, thereby rendering the insertion to be highly intrusive to the end viewers.

U.S. Pat. No. 5,731,846, issued on 24 Mar. 1998 to Kreitman et al. and entitled “Method and System for Perspectively Distorting an Image and Implanting Same into a Video Stream” describes a method and apparatus for image implantation that incorporates a 4-colour Look-Up-Table (LUT) to capture different objects of interest in the video scene. By selecting the target region to be a significant part of the playing field (inner court), the inserted image appears to be intruding into the viewing space of the end viewers.

U.S. Pat. No. 6,292,227, issued on 18 Sep. 2001 to Wilf et al. and entitled “Method and Apparatus for Automatic Electronic Replacement of Billboards in a Video Image” describes apparatus to replace an advertising hoarding image in a video image automatically. Using an elaborate calibration set-up that relies on camera sensor hardware, the image locations of the hoarding are recorded and a chroma colour surface is manually specified. During live camera panning, the hoarding image locations are retrieved and replaced by virtual an advertisement using the chroma-keying technique.

Known systems need intensive labour to identify suitable target regions for advertisement insertion. Once identified, these regions are fixed and no other new regions allowable. Hoarding positions are identified because those are the most natural regions that viewers would find advertising information. Perspective maps are also used to attempt realistic advertisement implantation. These efforts collectively contribute to elaborate manual calibration.

There is a conflicting requirement between the continual push for greater advertising effectiveness amongst advertisers, and the viewing pleasure of the end-viewers. Clearly, realistic virtual ad implants on suitable locations (such as advertising hoardings) are compromises enabled by current 3D graphics technology. However, there are only so many hoardings within the video image frames. As a result advertisers push for more spaces for advertisement implantation.

### SUMMARY

According to one aspect of the present invention, there is provided a method of inserting additional content into a video segment of a video stream, the video segment comprising a series of video frames. The method comprises: receiving the video segment, determining a frame content, determining suitability for insertion and inserting the additional content. Determining a frame content is determining the frame content of at least one frame of the video segment. Determining the suitability of insertion of additional content is based on the determined frame content. Inserting the additional content is inserting the additional content into the frames of the video segment depending on the determined suitability.

According to another aspect of the present invention, there is provided a method of inserting further content into a video segment of a video stream, the video segment comprising a series of video frames. The method comprises receiving the video stream, detecting static spatial regions within the video stream and inserting the further content into the detected static spatial regions.

According to a third aspect of the present invention, there is provided video integration apparatus operable according to the method of either above aspect.

According to a fourth aspect of the present invention, there is provided video integration apparatus for inserting additional content into a video segment of a video stream, the video segment comprising a series of video frames. The apparatus comprises means for receiving the video segment, means for determining the frame content, means for determining at least one first measure and means for inserting the additional content. The means for determining the frame content determines the frame content of at least one frame of the video segment. The means for determining at least one first measure determines at least one first measure for the at least one frame indicative of the suitability of insertion of additional content, based on the determined frame content. The means for inserting inserts the additional content into the frames of the video segment depending on the determined at least one first measure.

According to a fifth aspect of the present invention, there is provided video integration apparatus for inserting further content into a video segment of a video stream, the video segment comprising a series of video frames. The apparatus comprises means for receiving the video stream, means for detecting static spatial regions within the video stream and means for inserting the further content into the detected static spatial regions.

According to a sixth aspect of the present invention, there is provided apparatus according to the fourth or fifth aspects operable according to the method of the first or second aspect.

According to a seventh aspect of the present invention, there is provided a computer program product for inserting additional content into a video segment of a video stream, the video segment comprising a series of video frames. The computer program product comprises a computer usable medium and a computer readable program code means embodied in the computer usable medium and for operating according to the method of the first or second aspect.

According to an eighth aspect of the present invention, there is provided a computer program product for inserting additional content into a video segment of a video stream, the video segment comprising a series of video frames. The computer program product comprises a computer usable medium and a computer readable program code means embodied in the computer usable medium. When the computer readable program code means is downloaded onto a computer, it renders the computer into apparatus as according to any one of the third to the sixth aspects.

Using the above aspects, there can be provided methods and apparatus that insert virtual advertisements or other virtual contents into a sequence of frames of a video presentation by performing real-time content-based video frame processing to identify suitable locations in the video for implantation. Such locations correspond to both the temporal segments within the video presentation and the regions within an image frame that are commonly considered to be of lesser relevance to the viewers of the video presentation. This invention presents a method and apparatus that allows a non-intrusive means to incorporate additional virtual content into a video presentation, facilitating an additional channel of communications to enhance greater video interactivity.

### BRIEF DESCRIPTION OF THE DRAWINGS

The present invention is further described by way of non-limitative example, with reference to the accompanying drawings, in which:—

FIG. 1 is an overview of an environment in which the present invention is deployed;

FIG. 2 is a flowchart representing an overview relating to the insertion of video content;

FIG. 3 is a schematic overview of the insertion system implementation architecture;

FIG. 4 is a flowchart illustrating the “When” and “Where” processing for the insertion of video content;

FIGS. 5A to 5L are examples of video frames and their respective FRVMs;

FIGS. 6A and 6B are examples of two video frames and RRVMs of regions therein;

FIG. 7 is a flowchart of examples of an processes conducted to generate attributes for determining the FRVM;

FIG. 8 is a flowchart of an exemplary method of determining if there is a new shot;

FIG. 9 is a flowchart showing various attributes that are determined for generating shot attributes;

FIG. 10 is a flowchart relating to determining the FRVM for a segment based on play break detection;

FIG. 11 is a flowchart detailing steps used to determine if the current video frame is a field-view image;

FIG. 12 is a flowchart exemplifying a process for determining when a central mid-field is in view;

FIG. 13 is a flowchart detailing whether to set an FRVM based on mid-field play;

FIG. 14 is a flowchart relating to computing audio attributes of an audio frame;

FIG. 15 is a flowchart showing how audio attributes are used in making decisions on the FRVM;

FIG. 16 is a flowchart relating to insertion computation based on homogenous region detection;

FIG. 17 is a flowchart relating to insertion computation based on static region detection;

FIG. 18 is a flowchart illustrating a process for detecting static regions;

FIG. 19 is a flowchart illustrating an exemplary process used for dynamic insertion in mid-field frames;

FIG. 20 is a flowchart illustrating steps involved in performing content insertion;

FIG. 21 is a flowchart illustrating insertion computation for dynamic insertion around the goal mouth; and

FIG. 22 is a schematic view of a computer system for implementing aspects of the invention.

### DETAILED DESCRIPTION

Embodiments of the present invention are able to provide content-based video analysis that is capable of tracking the progress of a video presentation, and assigning a first relevance-to-viewer measure (FRVM) to temporal segments (frames or frame sequences) of the video and finding spatial segments (regions) within individual frames in the video that are suitable for insertion.

Using video of association football (soccer) as an example, and referred to hereafter simply as football, it would not be unreasonable to generalise that viewers are focused on the immediate area around the soccer ball. The relevance to the viewer of the content goes down for regions of the image the further they are concentrically from the ball. Likewise, it would not be unreasonable to judge that a scene where the camera view is focused on the crowd, which is usually of no relevance to the game, is of lesser relevance to the viewer, as would be a player-substitution scene. Compared to scenes where there is high global motion, there is player build-up or the play is closer to the goal-line, the crowd scenes and player-substitution scenes are of lesser importance to the play.

Embodiments of the invention provide a system, method and software for inserting content into video presentations. For ease of terminology, the term “system” alone will generally be used. However, no specific limitation is intended to exclude methods, software or other ways of embodying or using the invention. The system determines an appropriate target region for content implantation to be relatively non-intrusive to the end viewers. These target regions may appear at any arbitrary location in the image, as are determined to be sufficiently non-intrusive by the system.

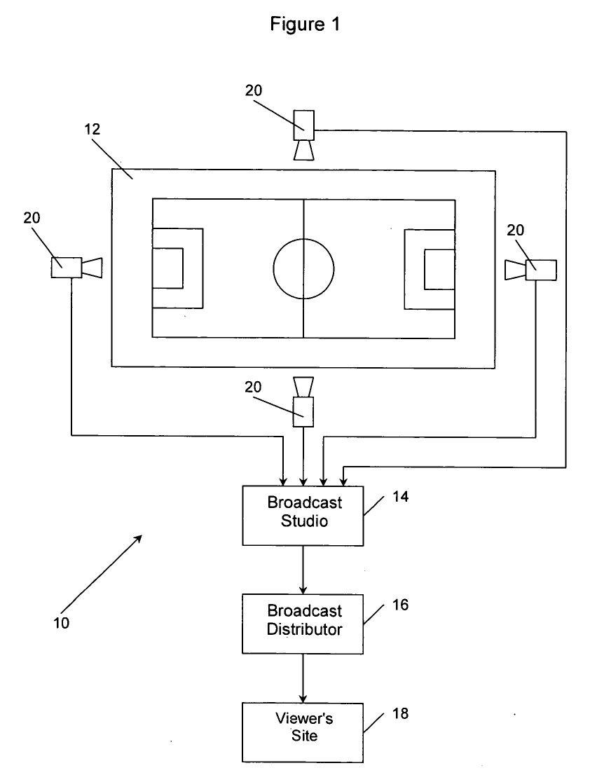

FIG. 1 is an overview of an environment in which an embodiment of the present invention is deployed. FIG. 1 includes schematic representations of certain portions of an overall system 10, from the cameras filming an event, to the screen on which the image is viewed by an end viewer.

The relevant portions of the system 10 as appear in FIG. 1 include the venue site 12, where the relevant event takes place, a central broadcast studio 14, a local broadcast distributor 16 and the viewer's site 18.

One or more cameras 20 are set up at the venue site 12. In a typical configuration for filming a sporting event such as a football match (as is used for the sake of example throughout much of this description), broadcast cameras are mounted at several peripheral view-points surrounding the soccer field. For instance, this configuration usually minimally involves a camera located at a position that overlooks the centre field line, providing a grand-stand view of the field. During the course of play, this camera pans, tilts and zooms from this central position. There may also be cameras mounted in the corners or closer to the field, along the sides and ends, in order to capture the game action from a closer view. The varied video feeds from the cameras 20 are sent to the central broadcast studio 14, where the camera view to be broadcast is selected, typically by a broadcast director. The selected video is then sent to the local distribution point 16, that may be geographically spaced from the broadcast studio 14 and the venue 12, for instance in a different city or even a different country.

In the local broadcast distributor 16, additional video processing is performed to insert content (typically advertisements) that may, usefully be relevant to the local audience. Relevant software and systems sit in a video integration apparatus within the local broadcast distributor 16, and select suitable target regions for content insertion. The final video is then sent to the viewer's site 18, for viewing by way of a television set, computer monitor or other display.

Most of the features described in detail herein take place within the video integration apparatus in the local broadcast distributor 16 in this embodiment. Whilst the video integration apparatus is described here as being within the local broadcast distributor 16, it may instead be within the broadcast studio 14 or elsewhere as required. The local broadcast distributor 16 may be a local broadcaster or even an internet service provider.

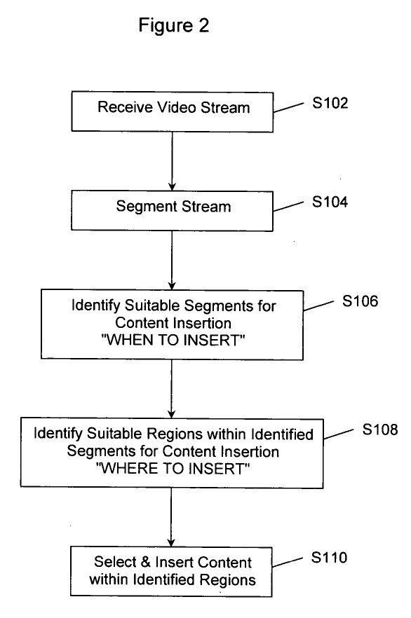

FIG. 2 is a flowchart representing an overview of the video processing algorithm used in the insertion of video content according to an embodiment, as occurs within the video integration apparatus in the local broadcast distributor 16 in the system of FIG. 1.

The video signal stream is received (step S102) by the apparatus. As the original video signal stream is received, the processing apparatus performs segmentation (step S104) to retrieve homogenous video segments, which are homogenous both temporally and spatially. The homogenous video segments correspond to what are commonly called “shots”. Each shot is a collection of frames from a continuous feed from the same camera. For football, the shot length might typically be around 5 or 6 seconds and is unlikely to be less than 1 second long. The system determines the suitability of separate video segments for content insertion and identifies (step S106) those segments that are suitable. This process of identifying such segments is, in effect, answering the question of “WHEN TO INSERT”. For those video segments which are suitable for content insertion, the system also determines the suitability of spatial regions within a video frame for content insertion and identifies (step S108) those regions that are suitable. The process of identifying such regions is, in effect, answer the question of “WHERE TO INSERT”. Content selection and insertion (step S110) then occurs in those regions where it is found suitable.

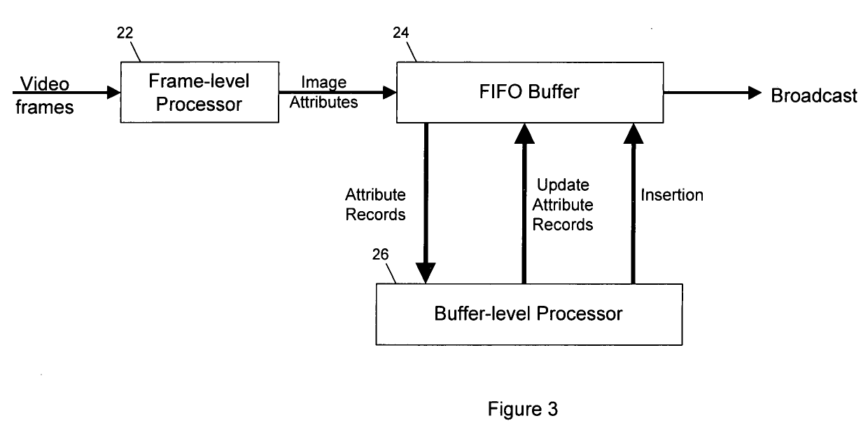

FIG. 3 is a schematic overview of the insertion system implementation architecture. Video frames are received at a frame-level processing module (whether a hardware or software processor, unitary or non-unitary) 22, which determines image attributes of each frame (e.g. RGB histograms, global motion, dominant colours, audio energy, presence of vertical field line, presence of elliptical field mark, etc.)

The frames and their associated image attributes generated at the frame-level processing module 22 proceed to a first-in first-out (FIFO) buffer 24, where they undergo a slight delay as they are processed for insertion, before being broadcast. A buffer-level processing module (whether a hardware or software processor, unitary or non-unitary) 26 receives attribute records for the frames in the buffer 24, generates and updates new attributes based on the input attributes, sending the new records to the buffer 24, and makes the insertions into the selected frames before they leave the buffer 24.

The division in processing between frame-level processing and buffer-level processing is generally between raw data processing vs. meta data processing. The buffer-level processing is more robust, as it tends to rely on statistical aggregation.

The buffer 24 provides video context to aid in insertion decisions. A relevance-to-viewer measure FRVM, is determined within the buffer-level processing module 26 from the attribute records and context. The buffer-level processing module 26 is invoked for each frame that enters the buffer 24 and it conducts relevant processing on each frame within one frame time. Insertion decisions can be made on a frame by frame basis or for a whole segment on a sliding window basis or for a shot, in which case insertion is made for all the frames within the segment and no further processing of the individual frames is necessary.

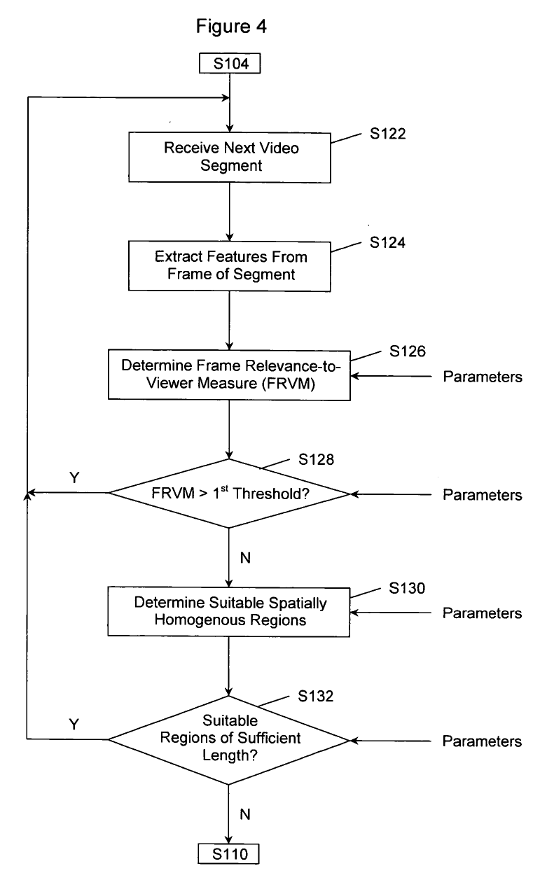

The determination processes for determining “When” and “Where” to insert content (steps S106 and S108) are described now in more detail with reference to the flowchart of FIG. 4.

As a result of segmentation (step S104 of FIG. 2), the next video segment is received. A set of visual features is extracted from the first video frame (step S124) of the segment. From this set of visual features, and using parameters obtained from a learning process, the system determines (step S126) a first relevance-to-viewer measure, which is a frame relevance-to-viewer measure (FRVM) and compares (step S128) that first measure against a first threshold which is a frame threshold. If the frame threshold is exceeded, this indicates that the current frame (and therefore the whole of the current shot) is too relevant to the viewer to interfere with and is therefore not suitable for content insertion. If the first threshold is not exceeded, the system proceeds to determine (step S130) spatially homogenous regions within the frame, where insertion may be possible, again using parameters obtained from a learning process. If spatially homogenous regions of a low viewer relevance and lasting sufficient time are found, the system proceeds to content selection and insertion (step S10 of FIG. 2). If the frame is not suitable (S128) or no region is suitable (step S132), then the whole video segment is rejected and the system reverts to step S122 to retrieve the next video segment to extract features from the first frame of that next video segment.

As the video frames are received by the video integration apparatus, they are analysed for their feasibility for content insertion. The decision process is augmented by a parameter data set, which includes key important decision parameters and the thresholds needed for the decisions.

The parameter set is derived via an off-line training process, using a training video presentation of the same type of subject matter (e.g. a football game for training use of the system on a football game, a rugby game for training use of the system on a rugby game, a parade for training use of the system on a parade). Segmentation and relevance scores in the training video are provided by a person viewing the video. Features are extracted from frames within the training video and, based on these and the segmentation and relevance scores, the system learns statistics such as video segment duration, percentage of usable video segments, etc, using a relevant learning algorithm. This data is consolidated into the parameter data set to be used during actual operation.

For instance, the parameter set may specify a certain threshold for the colour statistics of the playing field. This is then used by the system to segment the video frame into regions of playing field and non playing field. This is a useful first step in determining active play zones within the video frame. It would be commonly accepted as a fact that non-active play zones are not the focal point for end viewers and therefore can be attributed with a lesser relevance measure. While the system relies on the accuracy of the parameter set that is trained via an off-line process, the system also performs its own calibration with respect to content based statistics gathered from the received video frames of the actual video into which content is to be inserted. During this bootstrapping process or initialisation step, no content is inserted. The time duration for this bootstrap is not long and, considering the entire duration of the video presentation, is merely a fraction of opportunity time lost in content viewing. The calibration can be based on comparison with previous games, for instance at whistle blowing, or before, when viewers tend to take a more global interest in what is on screen.

Whenever a suitable region inside a frame, within a video segment, is designated for content insertion, content is implanted into that region, and typically stays exposed for a few seconds. The system determines the exposure time duration for the inserted content based on information from the off-line learning process. Successive video frames of a homogenous video segment remain visually homogenous. Thus it is highly likely that the target region, if it is deemed to be non-intrusive in one frame, and therefore suitable for content insertion, would stay the same for the rest of the video segment and therefore for the entire duration of the few seconds of inserted content exposure. For the same reason, if no suitable insertion region can be found, the whole video segment can be rejected.

The series of computation steps in FIG. 4 (discussed above) begins with the first frame in a new video segment (for example, from a change in camera view). Alternatively, the frame that is used can be some other frame from within the video segment, for instance a frame nearer the middle of the segment. Further, in another alternative embodiment if the video segments are sufficiently long, several temporally spaced individual frames from within the sequence are considered to determine if content insertion is suitable.

There may also be a question of “WHAT TO INSERT”, if there is more than one possibility, and this may depend upon the target regions. The video integration apparatus of this embodiment also includes selection systems for determining insertion content suitable for the geometric sizes and/or locations of the designated target regions. Depending on the geometrical property of the target regions so determined by the system, a suitable form of content might then be implanted. For instance, if a small target region is selected, then a graphic logo might be inserted. If an entire horizontal region is deemed suitable by the system, then an animated text caption might be inserted. If a sizeable target region is selected by the system, a scaled-down video insert may be used. Also different regions of the screen may attract different advertising fees and therefore content may be selected based on the importance of the advertisement or level of fees paid.

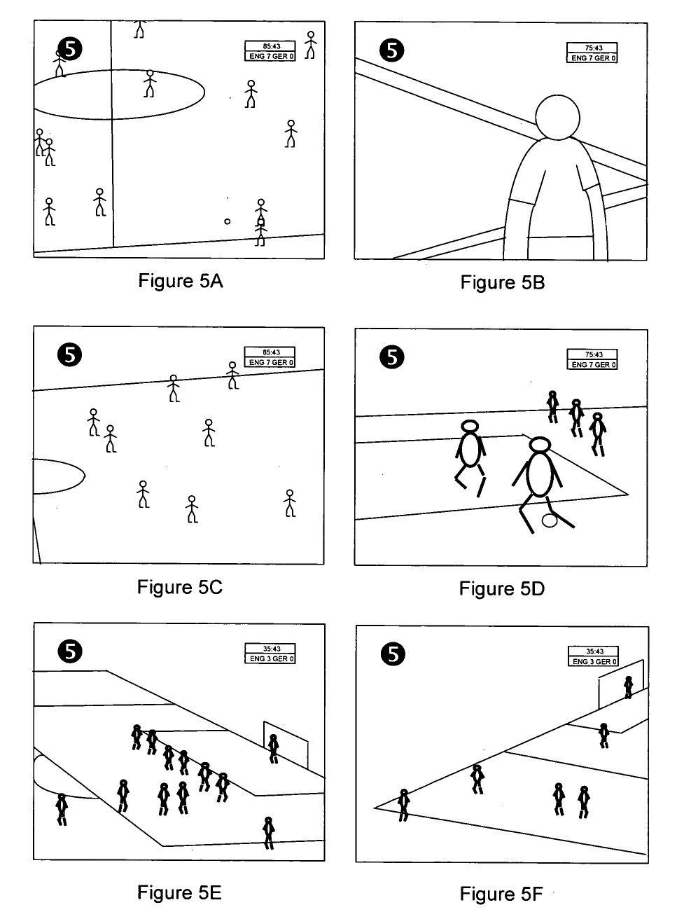

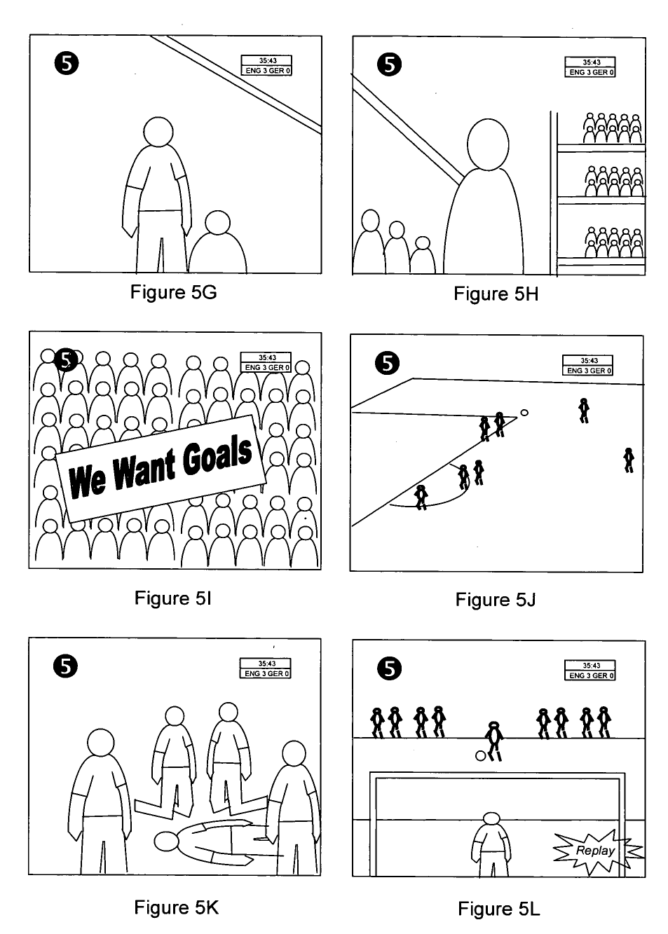

FIGS. 5A to 5L show examples of video frames from a football game. The content within each video frame indicates the progress of play, which gives it a corresponding FRVM. For example, video frames depicting play that is near to the goal-mouth will have a high FRVM, while video frames depicting play that is at the centre mid-field have a lower FRVM. Also video frames showing a close-up of a player or spectators have low FRVMs. Content-based image/video analysis techniques are used to determine the thematic progress of the game from the images and thereby to determine the FRVMs of segments. The thematic progress is not just a result of analysis of the current segment but may also rely upon the analysis of previous segments. Thus the same video segment may have a different FRVM depending on what preceded it. In this example, the FRVM values vary from 1 to 10, 1 being the least relevant and 10 being the most relevant.

In FIG. 5A, the frame is of play at centre-field−FRVM=5;
In FIG. 5B, there is a close-up of a player, indicating a play break−FRVM=4;
In FIG. 5C, the frame is of normal build-up play−FRVM=6;
In FIG. 5D, the frame is part of a following video segment, following a player with the ball−FRVM=7;
In FIG. 5E, the frame is of play in one of the goal areas−FRVM=10;
In FIG. 5F, the frame is of play to the side of a goal area−FRVM=8;
In FIG. 5G, there is a close-up of the referee, indicating a play break or foul−FRVM=3;
In FIG. 5H, there is a close-up of a coach−FRVM=3;
In FIG. 5I, there is a close-up of the crowd−FRVM=1;
In FIG. 5J, the frame is of play progressing towards one of the goal areas−FRVM=9;
In FIG. 5K, there is a close-up of an injury, indicating a play break−FRVM=2; and
In FIG. 5L, there is a replay−FRVM=10.

Table 1 lists various video segment categories and examples of FRVMs that might be applied to them.

TABLE 1
FRVM table

| | Frame Relevance to Viewer |
|---|---|
| Video segment Category | Measure (FRVM) [1 . . . 10] |
| Field View (mid field) | <=5 |
| Field View (build-up play) | 5-6 |
| Field View (goal area) | 9-10 |
| Close-up | <=3 |
| Following | <=7 |
| Replay | 8-10 |

The values from the table are used by the system in allocating FRVMs and can be adjusted on-site by an operator, even during a broadcast. One effect of modifying the FRVMs in the respective categories will be to modify the rate of occurrence of content insertion. For example, if the operator were to set all the FRVMs in Table 1 to be zero, denoting low relevance to viewer measure for all types of video segments, then during presentation, the system will find more instances of video segments with a FRVM passing the threshold comparison, resulting in more instances of content insertion. This might appeal to a broadcaster when game time is running out, but he is still required to display more advertising content (for instance if a contract requires that an advertisement will be displayed a minimum number of times or for a minimum total length of time). By changing the FRVM table directly, he changes the rate of occurrence of virtual content insertion. The values in Table 1 may also be used as a way of distinguishing free to view broadcasting (high FRVM values), against pay to view broadcasting (low FRVM values) of the same event. Different values in Table 1 would be used for the feeds of the same broadcast to different broadcast channels.

The decision on whether video segments are suitable for content insertion is determined by comparing the FRVM of one frame against a defined threshold. For example, insertion may only be allowed where the FRVM is 6 or lower. The threshold value may also or instead be changed as a way of changing the amount of advertising that appears. When a video segment has thus been deemed to be suitable for content insertion, one or more video frames are analysed to detect suitable spatial regions for the actual content insertion.

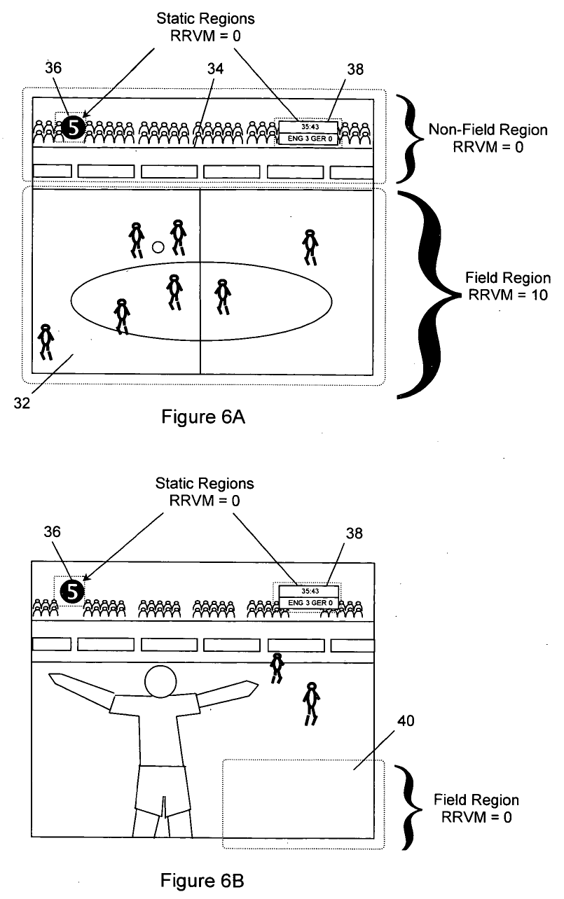

FIGS. 6A and 6B are schematic frame images showing examples of regions that generally have low relevance to the viewer. In deciding which regions are worth considering for insertion, different regions may be allocated a different relevance-to-viewer measure (RRVM), for instance of only 0 or 1 (1 being relevant) or, more preferably between, say, 0 and 5.

FIGS. 6A and 6B are two different frames of low FRVM. FIG. 6A is a panoramic view of play at centre-field (FRVM=5), and FIG. 6B is a close-up of a player (FRVM=4). There is normally no need to determine the spatially homogenous regions in frames of high FRVM as these do not tend to have content inserted. In FIG. 6A, the region of the field 32 has a high relevance to the viewer, RRVM of 5, as play is spread out over the field. However, the non-field region 34 has a low relevance to the viewer, RRVM of 0, as have the regions of the two static logos 36, 38, superimposed on the non-field region 34. In FIG. 6B the empty field portions of the field region has a low or minimum RRVM (e.g. 0), as have the regions of the two static logos 36, 38. The centre player himself has a high RRVM, possibly even a maximum RRVM (e.g. 5). The crowd has a slightly higher RRVM than the empty field portion (e.g. 1). In this example, the insert is constrained to the empty field portion 40 at the bottom right-hand corner. This is because this area tends to be the most commonly available or suitable portion of a frame for insertion. The insertion can then be placed there with the expectation of not too much changing around. Further, whilst other places may also be available for insertion in the same frame, many broadcasters and viewers may prefer only one insertion on the screen at a time.

Determining Suitable Video Frames for Content Insertion (WHEN TO INSERT?) [Step S106 of FIG. 2]

In determining the feasibility of the current video segment for content insertion, a or the principal criteria is the relevance measure of the current frame, with respect to the current thematic progress of the original content. To achieve this, the system uses content-based video processing techniques that are well-known to those skilled in the field. Such well-known techniques include those described in: “An Overview of Multi-modal Techniques for the Characterization of Sport Programmes”, N. Adami, R. Leonardi, P. Migliorati, Proc. SPIE -VCIP'03, pp. 1296-1306, 8-11 July, 2003, Lugano, Switzerland, and “Applications of Video Content Analysis and Retrieval”, N. Dimitrova, H-J Zhang, B. Shahraray, I. Sezan, T. Huang, A. Zakhor, IEEE Multimedia, Vol. 9, No. 3, July-September 2002, pp. 42-55

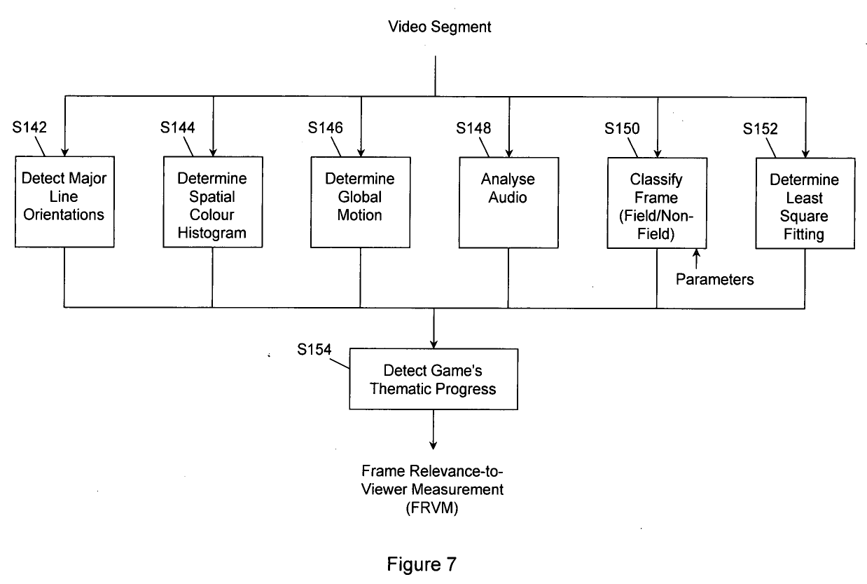

FIG. 7 is a flowchart showing examples of various processes, carried out in the frame-level and buffer-level processors, on sequences of video frames to generate FRVMs.

A Hough-Transform based line detection technique, using a Hough-Transform is used to detect major line orientations (step S142). A RGB spatial colour histogram is determined to work out if a frame represents a shot change and also to determine field and non-field regions (step S144). Global motion is determined between successive frames (step S146) and also on single frames based on encoded movement vectors. Audio analysis techniques are used to track the audio pitch and excitement level of the commentator, based on successive frames and segments (step S148). The frame is classified as a field/non-field frame (step S150). A least square fitting is determined, to detect the presence of an ellipse (step S152). There may be other operations as well or instead depending on the event being broadcast.

Signals may also be provided from the cameras, either supplied separately or coded onto the frames, indicating their current pan and tilt angles and zoom. As these parameters define what is on the screen in terms of the part of the field and the stands, they can be very useful in helping the system identify what is in a frame.

The outputs of the various operations are analysed together to determine both segmentation and the current video segment category and the game's thematic progress (step S154). Based on the current video segment category and the game's thematic progress, the system allocates a FRVM, using the available values for each category of video segment from Table 1.

For example, where the Hough-Transform based line detection technique indicates relevant line orientations and the spatial colour histogram indicates relevant field and non-field regions, this may indicate the presence of a goal mouth. If this is combined with commentator excitement, the system may deem that goal mouth action is in progress. Such a segment of video is of the utmost relevance to the end viewers, and the system would give the segment a high FRVM (e.g. 9 or 10), thereby restraining from content insertion. The Hough Transform and elliptical least square fitting, are very useful for this specific determination of mid-field frames, each of which processes is a well understood and state-of-art technique in content-based image analysis.

Assuming that a previous video segment was of goal mouth action, the system might next, for example, detect that the field of play has changed, via a combination of the content based image analysis techniques. The intensity in the audio stream has calmed, global camera motion has slowed, and the camera view is now focused on a non-field view, for example that of a player close-up (e.g. FRVM<=3). The system then deems this to be an opportune time for content insertion.

Various methods are now described, which relate to some of the processes that may be applied in generating FRVMs. The embodiments are not necessarily limited by way of having to have any or all of these or only having these methods. Other techniques may be used as well or instead.

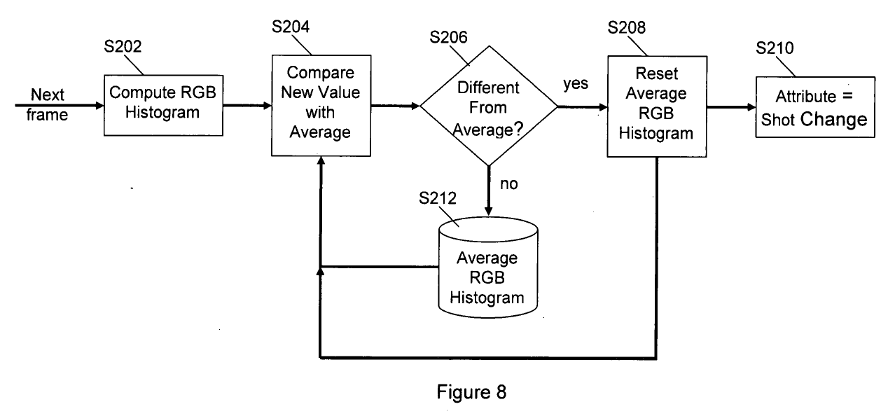

FIG. 8 is a flowchart of an exemplary method of determining if a current frame is the first frame in a new shot, thereby being useful in segmentation of the stream of frames. For an incoming video frame, the system computes a RGB histogram (step S202) (in the frame-level processor). The RGB histogram is passed to the buffer in association with the frame itself. On a frame by frame basis, the buffer-level processor statistically compares the individual histograms with an average histogram of previous frames (averaged over the frames since the last new shot was determined to have started) (step S204). If the result of the comparison is that there is a significant difference (step S206), e.g. 25% of the bins (bars) show a change of 25% or more, then the average is reset, based on the RGB histogram for the current frame (step S208). The current frame is then given the attribute of being a shot change frame (step S210). For the next input frame, the comparison is then made with the new, reset “average”. If the result of a comparison is that there is no significant difference (step S206), then the average is recalculated, based on the previous average and the RGB histogram for the current frame (step S212). For the next input frame, the comparison is then made with the new average.

Once the system has determined where shots begin and end, shot attributes are determined on a shot by shot basis within the buffer. The buffer-level processing module collates images within a shot and computes the shot-level attributes. The sequence of shot attributes that is generated represents a compact and abstract view of the video progression. These can be used as inputs to a dynamic learning model for play break detection.

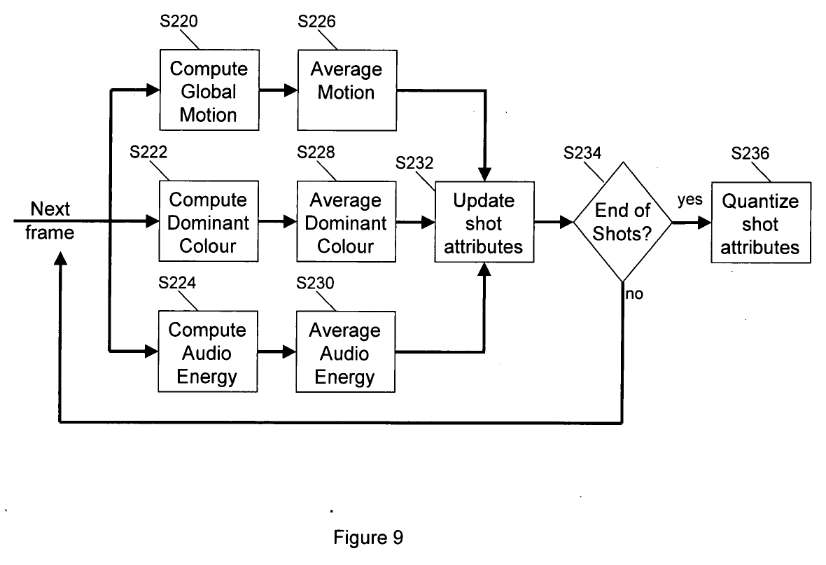

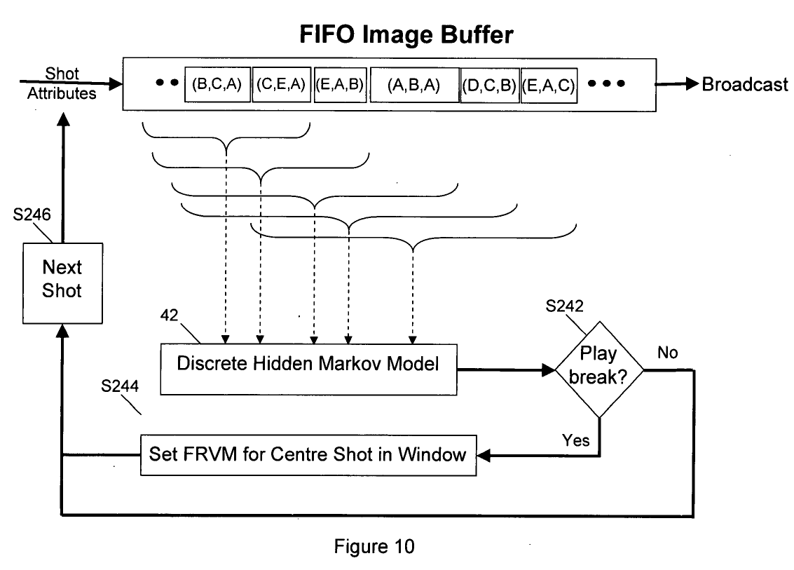

FIGS. 9 and 10 relate to play break detection. FIG. 9 is a flowchart showing various additional frame attributes that are determined for generating shot attributes for use in play break detection. For each frame, global motion (step S220), the dominant colour (e.g. the colour which, in an RGB histogram has a bin which is at least twice the size of any other bin in the histogram) (step S222) and the audio energy (step S224) are calculated at the frame-level processor. These are then passed to the buffer in association with the frame.

For incoming frames, the buffer-level processor determines an average of the global motion for the shot so far (step S226), an average of the dominant colour (averaging R, G B) for the shot so far (step S228), as well as an average of the audio energy for the shot so far (step S230). The three new averages are used to update the shot attributes for the current shot, in this example becoming those attributes (step S232). If the current frame is the last frame in the shot (step S234), the current shot attributes are quantized into discrete attribute values (step S236) before being written to the shot attribute record for the current shot. If the current frame is not the last frame in the shot (step S234), the next frame is used to update the shot attribute values.

FIG. 10 is a flowchart relating to determining the FRVM for a segment based on play break detection. Individual quantized shot attributes, for instance as determined by way of the method exemplified in FIG. 9, are represented in FIG. 10 as discrete and individual letters of the alphabet, each of the shot attributes in this embodiment having three such letters. A sliding window of a fixed number of shot attributes within the sequence of shot alphabets (in this example, five of them) is fed to a discrete hidden Markov model (HMM) 42 for play-break recognition of the shot in the middle of the window, based on prior training of the model. If a break is classified (step S242), the shot attributes are updated for the middle shot within the window to indicate that it is a play break shot and the FRVM for that shot is set accordingly (step S244) and the process then continues for the next shot (step S246). If a break is not classified (step S242), the FRVM for the middle shot is not changed, after which the process then continues for the next shot (step S246).

The play break detection process described with reference to FIG. 10 requires a buffer that holds at least three shots, together with a memory for the HMM that retains all relevant information from the two preceding shots. Alternatively, the buffer can be long enough for at least 5 shots, as shown in FIG. 10. The disadvantage of this is that it makes the buffer quite large. Even if shot lengths are limited to 6 seconds, this would make a buffer length of at least 18 seconds, whereas around 4 seconds would be the preferred maximum length.

In an alternative embodiment, a shorter buffer length is possible, using a continuous HMM, without quantization. Shots are limited in length to around 3 seconds; the HMM takes features from every third frame in the buffer and, on the determination of a play break, sets the FRVM for every frame in the buffer at the time as if it were a play break. Disadvantages of such an approach include limiting the shot lengths and the fact that the HMM requires a larger training set.

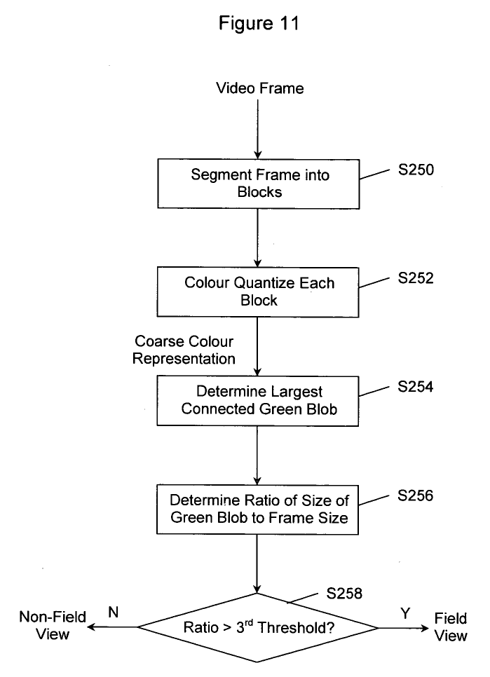

FIG. 11 is a flowchart detailing steps, at the frame-level processor, used to determine if the current video frame is a field-view image or not, which takes place in step S150 of FIG. 7. A reduced resolution image is first obtained from a frame by sub-sampling an entire video frame into a number of non-overlapping blocks (step S250), for example 32×32 such blocks. The colour distribution within each block is then examined to quantize it, in this example into either a green block or a non-green block (step S252), and produce a colour mask (in this example in green and non-green). The green colour threshold used is obtained from the parameter data set, (mentioned earlier). After each block is colour-quantized into green/non-green, this forms a type of coarse colour representation (CCR) of the dominant colour present in the original video frame. The purpose of this operation is to look for a video frame of a panoramic view of the field. The sub-sampled coarse representation of such a frame being sought would exhibit predominantly green blocks. Connected chunks of green (non-green) blocks are determined to establish a green blob (or non-green blob) (step S254). The system determines if this video frame is a field-view or not by computing the relative size of the green blob with respect to the entire video frame size (step S256), and comparing the ratio obtained against a pre-defined third threshold (also obtainable via the off-line learning process) (step S258). If the ratio is higher than the third threshold, the frame is deemed to be a field view. If the ratio is lower than the third threshold, the frame is deemed to be a non-field view.

It will be readily apparent that there may be more or fewer steps of differing order than are illustrated here without departing from the invention. For example, in the field/non-field classification step S150 in FIG. 7, a hard-coded colour threshold could be used to perform the field/non-field separation, instead of an adaptive green field colour threshold that as mentioned above. Additional routines may also be invoked to deal with a mismatch of the learnt parameter data set, and the visual features currently determined on the current video stream. Green is chosen in the above example assuming a predominantly grass pitch. The colours may change for different types of pitches or different dryness conditions of the pitch, for ice, for concrete, for tarmacadam surfaces etc.

If it is determined that a frame is a field view, then the image attributes for the frame are updated to reflect this. Additionally the image attributes may be updated with further image attributes for use in determining if the current frame is of mid-field play. The attributes used to determine mid-field play are the presence of a vertical field line, with co-ordinates, global motion and the presence of an elliptical field mark.

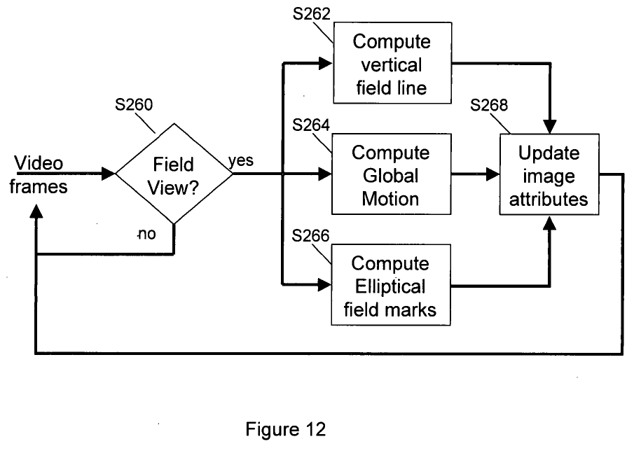

FIG. 12 is a flowchart showing various additional image attributes that are generated at frame-level processing for use in determining mid-field play. The buffer-level processor determines if a current frame is a field view (for example as described with reference to FIG. 11) (step S260). If the frame is not a field view, the system goes to the next frame to make the same determination. If the frame is a field view, the system determines the presence of vertical straight lines in the frame (step S262), computes the frame global motion (step S264) and determines the presence of elliptical field marks (step S266). The attributes for the frame are updated accordingly (step S268) and sent to the buffer. If this is a field view, there is an ellipse present and there is a vertical straight line, this is indicative of a mid-field view. If the frame is deemed to be a mid-field view, then the system determines an FRVM and proceeds to perform content insertion, if appropriate.

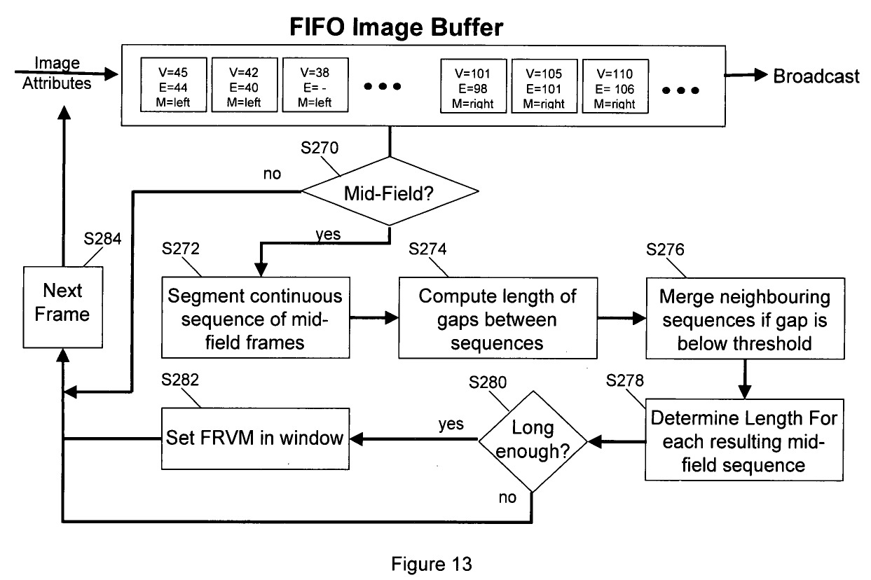

FIG. 13 is a flowchart detailing a method of determining whether to set an FRVM based on mid-field play. A frame is determined to be a mid-field frame play based on whether the image attributes indicate the presence of an ellipse and a vertical straight line, once it was determined as being a field view. Global motion attributes are also used to double check the ellipse and a vertical straight line, given that if global motion is to the left, the ellipse and a vertical straight line cannot also move left if they are correctly detected as lines on the pitch. Based on three successive frames, the buffer-level processor determines if the middle frame is a mid-field frame (step S270). Successive mid-field frames are collated into contiguous sequences (step S272). Gap lengths between individual sequences are computed (step S274). If a gap length between two such sequences is below a preset threshold (e.g. three frames), the two neighbouring sequences are merged (step S276). The length of each resulting individual sequence is determined (step S278) and compared against a further threshold (step S280) (e.g. around two seconds). If the sequence is deemed long enough, the individual frames are set as mid-field play frames (and/or the sequence as a whole is set as a mid-field play sequence) and the FRVM for each frame is set accordingly for the whole length of the sequence (the window) (step S282). The process then seeks the next frame (step S284) If the sequence is not deemed long enough, no special attribute is set and the FRVM of the various frames in the sequence is not affected. The process seeks the next frame (step S284).

Other field view shots can be merged into sequences in a similar manner. However, if the views are mid-field, there is a lower FRVM than for other sequences of field views.

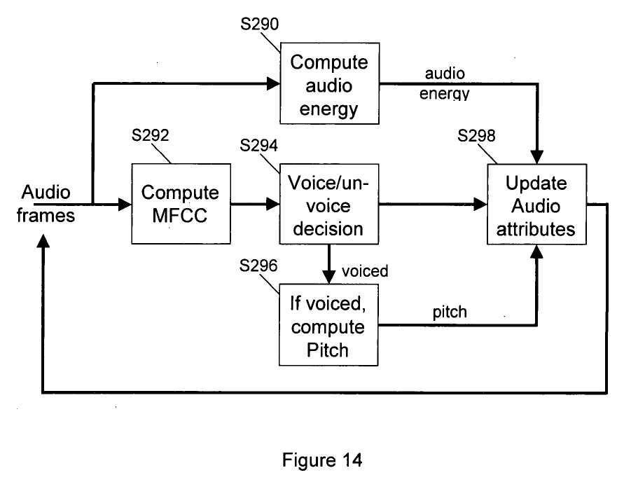

Audio can also be useful for determining a FRVM. FIG. 14 is a flowchart relating to computing audio attributes of an audio frame. For an incoming audio frame the audio energy (loudness level) is computed at the frame-level processor (step S290). Additionally, MeI-scale Frequency Cepstral Coefficients (MFCC) are calculated for each audio frame (step S292). Based on the MFCC features a decision is made as to whether the current audio frame (step S294) is voiced or unvoiced. If the frame is voiced, the pitch is computed (step S296) and the audio attributes are updated (step S298) based on the audio energy, the voiced/unvoiced decision and the pitch. If the frame is unvoiced, the audio attributes are updated based on the audio energy and the voiced/unvoiced decision alone.

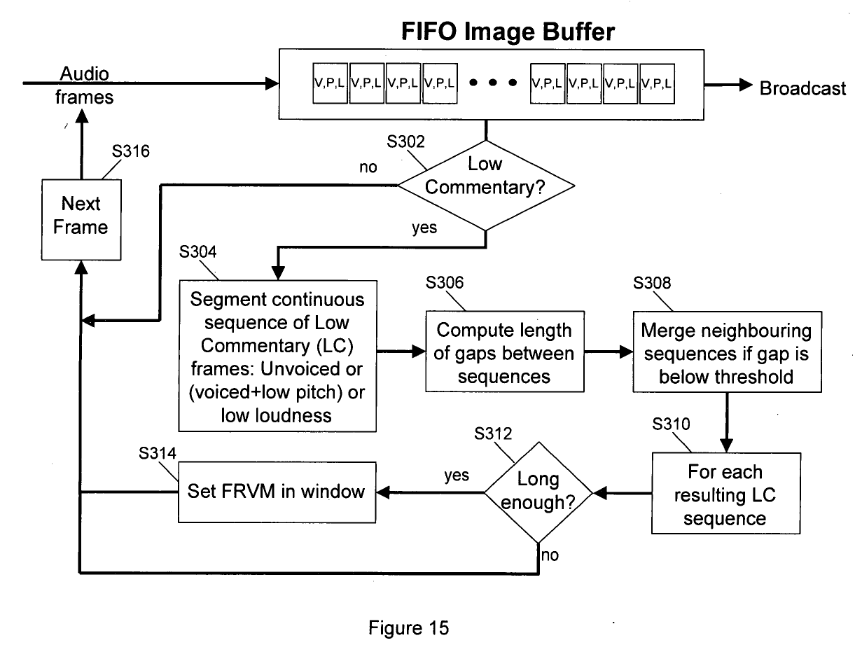

FIG. 15 is a flowchart showing how audio attributes are used in making decisions on the FRVM. Audio frames are determined from their attributes to be low commentary (LC) or not (step S302). The LC audio frames are segmented into contiguous sequences of LC frames (step S304), that is those frames which are: unvoiced, voiced but with a low pitch, or low loudness. Gap lengths between individual LC sequences are computed (step S306). If a gap length between two such LC sequences is below a preset threshold (e.g. around a half second), the two neighbouring sequences are merged (step S308). The length of each resulting individual LC sequence is determined (step S310) and compared against a further threshold (step S310) (e.g. around 2 seconds). If the sequence is deemed long enough, the attributes for the image frames associated with these audio frames are updated with the fact that these are low commentary frames and the FRVM is set accordingly for the whole length of the LC sequence (the window) (step S312). The process then passes to the next frame (step S312). If the sequence is not deemed long enough, the FRVM for the associated image frames remains unchanged and the process passes to the next frame (step S314).

Sometimes, a single frame or shot may have various FRVM values associated with or generated for it. The FRVM that applies depends on the precedence of the various determinations that have been made in connexion with the shot. Thus a play break determination will have precedence over an image which, during the normal course of play, such as around the goal, might be considered very relevant.

Determining Suitable Spatial Regions within a Video Frame for Content Insertion (WHERE TO INSERT?) [Step S108 of FIG. 2]

After a video segment has been determined to be suitable for content insertion, the system needs to know where to implant the new content (if anywhere). This involves identifying spatial regions within the video frame positioned such that, when new content is implanted therein, it will cause minimal (or acceptable) visual disruption to the end-viewer. This is achieved by segmenting the video frame into homogenous spatial regions, and inserting content into spatial regions considered to have a low RRVM, for instance lower than a pre-defined threshold.

FIGS. 6A and 6B mentioned earlier illustrate examples that suggest appropriate spatial regions where insertion of new content to the original video frame would likely cause little disruption to the end-viewer. These spatial regions may be referred to as “dead-zones”.

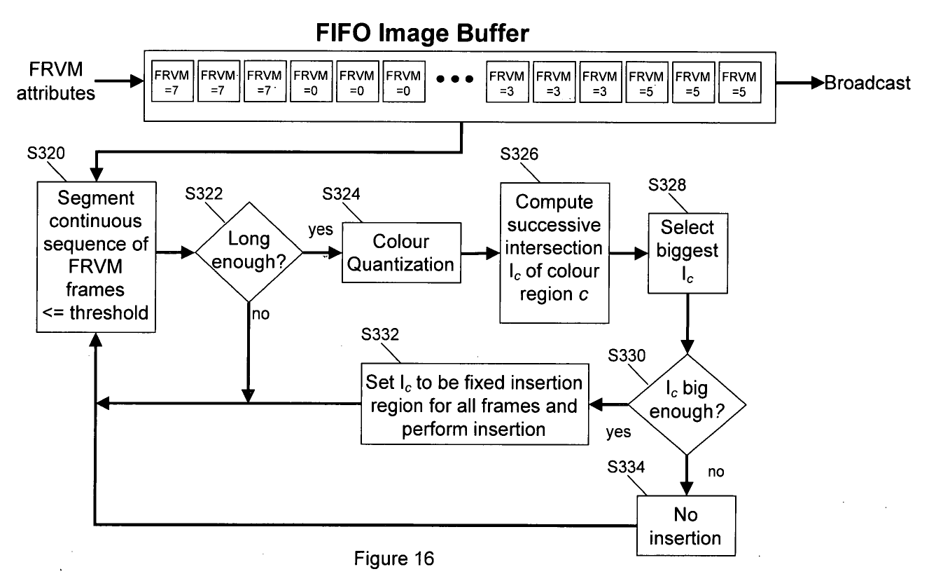

FIG. 16 is a flowchart relating to homogenous region detection based on constant colour regions, which regions tend to be given a low RRVM. The frames in the buffer have FRVMs associated with them. Where the frame attributes indicate a sequence of generally homogenous frames (e.g. shots) The frame stream is segmented into those continuous sequences of frames with a FRVM value below a first threshold are selected (step S320). For a current sequence a determination is made as to whether it is long enough for insertion (e.g. at least around 2 seconds) (step S322). If the current sequence is not long enough, the process reverts to step S320. If the current sequence is long enough a reduced resolution image is obtained from one of the frames by sub-sampling the entire video frame into a number of non-overlapping blocks, for example 32×32 such blocks. The colour distribution within each block is then examined to quantize it (step S324). The colour threshold used is obtained from the parameter data set (mentioned earlier). After each block is colour-quantized, this forms a type of coarse colour representation (CCR) of the dominant colour present in the original video frame. These initial steps segment the frame into homogenous regions of and successive intersections I_{c} (i.e. blobs) of a colour region c are determined (step S326). The biggest intersection I_{c} (i.e. biggest blob) is selected (step S328). A determination is made (step S330) as to whether there is a sufficient contiguous chunk of colour, both in height and width, for content insertion. If there is a sufficiently sized contiguous chunk of colour, then the relevant intersection I_{c} is fixed to be the insertion region for all frames within the current homogenous sequence and content insertion occurs in that chunk for all such frames (step S332). If there is no sufficiently sized intersection area, then the content insertion step for this video segment does not occur (step S334) and the system awaits the next video segment for which it is decided that insertion might occur.

The above description indicates that the largest blob of colour is chosen. This often depends on how the colour of the image is defined. In a football game the main colour is green. Thus, the process may simply define each portion as green or non-green. Further, the colour of the region that is selected may be important. For some types of insertion, insertion may only be intended over a particular region, pitch/non-pitch. For pitch insertion, it is only the size of the green areas that is important. For crowd insertion, it is only the size of the non-green areas that is important.

In a preferred embodiment of the present invention, the system identifies static unchanging regions in the video frames that are likely to correspond to a static TV logo, or a score/time bar. Such data necessarily occludes the original content to provide a minimal set of alternative information which may not be appreciated by most viewers. In particular, the implantation of a static TV logo is a form of visible watermark that broadcasters typically use for media ownership and identification purposes. However, such information pertains to the working of the business industry and in no way enhances the value of the video to end-viewers. Many people find them to be annoying and obstructive.

Detecting the locations of such static artificial images that are already overlaid on the video presentations and using these as alternative target regions for content insertion can be considered acceptable practice as far as the viewers are concerned, without infringing on the already limited viewing space of the video. The system attempts to locate such regions and others of low relevance to the thematic content of the video presentation. The system deems these regions to be non-intrusive to the end viewers, and therefore deems them suitable candidate target regions for content insertion.

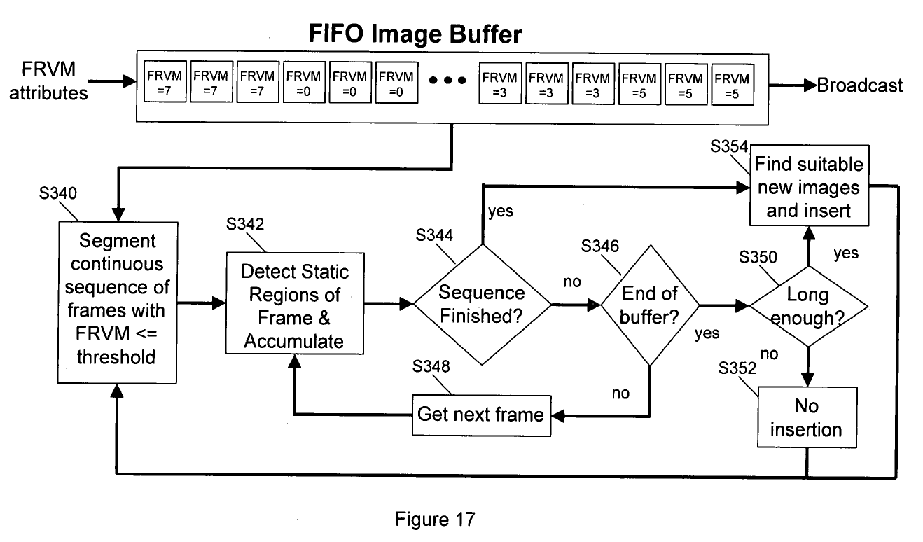

FIG. 17 is a flowchart relating to static region detection based on constant static regions, which regions tend to be given a low RRVM. The frame stream is segmented into continuous sequences of frames with FRVMs below a first threshold (step S340). The sequence lengths are all kept below the time length of the buffer. As a sequence passes through the buffer, the static regions within a frame are detected and the results are accumulated from frame to frame (step S342). Once the static regions from a frame have been detected, a determination is made of whether the sequence is finished (step S344). If the sequence has not finished, a determination is made of whether the beginning of the current sequence has reached the end of the buffer (step S346). If there are still frames in the sequence for which static regions have yet to be detected and the first frame in the sequence has not yet reached the end of the buffer, the next frame is retrieved (step S348) for detecting static regions. If the beginning of the current sequence has reached the end of the buffer at step S346), then the length of the sequence to this point is determined to see if it is long enough for content insertion (e.g. at least around two seconds long) (step S350). If the current sequence to this point is not long enough, the current sequence is abandoned for the purposes of static region insertion (step S352). Once static regions have been determined for all frames in the sequence at step S344 or the end of the buffer has been reached but the sequence is already long enough at step S350, suitable insertion images are determined and inserted in the static regions (step S354).

The homogenous region computation for insertion in this particular process is implemented as a separate independent processing thread which accesses the FIFO buffer via critical sections and semaphores. The computation time is limited to the duration that the first image (within the FRVM sequence) is kept within the buffer before leaving the buffer for broadcast. The entire computation is abandoned if no suitable length sequence of static regions is found before the beginning of the sequence leaves the buffer, and no image insertion will be made. Otherwise, the new image is inserted into a same static region of every frame within the current FRVM sequence, after which, in this embodiment, these same frames are processed no further for insertion.

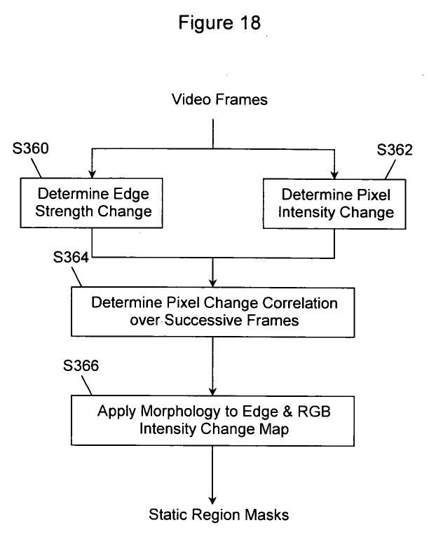

FIG. 18 is a flowchart illustrating a process for detecting static regions, such as may be used in step S342 of the process of FIG. 17, where it is likely that TV logos and other artificial images have been implanted onto the current video presentation. The system characterises each pixel in a series of video frames with a visual property or feature made up of two elements: directional edge strength change (step S360) and RGB intensity change (step S362). The frames in which the pixels are so characterised are logged over a time-lag window of a pre-defined length, for example, 5 seconds. The pixel property change over successive frames is recorded and its median and deviation and a correlation are determined and compared against a pre-defined threshold (step S364). If the change is larger than the pre-defined threshold, then the pixel is registered currently as non-static. Otherwise, it is registered as static. A mask is built up over such a sequence of frames.

Every pixel that is unchanged over the last X frames (that are being checked, rather than necessarily X contiguous frames) is deemed to belong to a static region. In this case X is a number that is deemed suitable to decide whether a region is static. It is selected based on how long one would expect a pixel to stay the same for a non-static region and the gap between successive frames used for this purpose. For example with a time lag of 5 seconds between frames, X might be 6 (total time 30 seconds). In the case of an on-screen clock, the clock frame may stay fixed, but the clock value itself changes. This may still be deemed static based on an averaging (gap fill) determination for the interior of the clock frame.

Each pixel is continually or regularly analysed to determine if it changes, in order to ensure the currency of its static status registration. The reason is that these static logos may be taken off at different segments of the video presentation, and may appear again at a later time. A different static logo may also appear, at a different location. Hence, the system maintains the most current set of locations where static artificial images are present in the video frames.

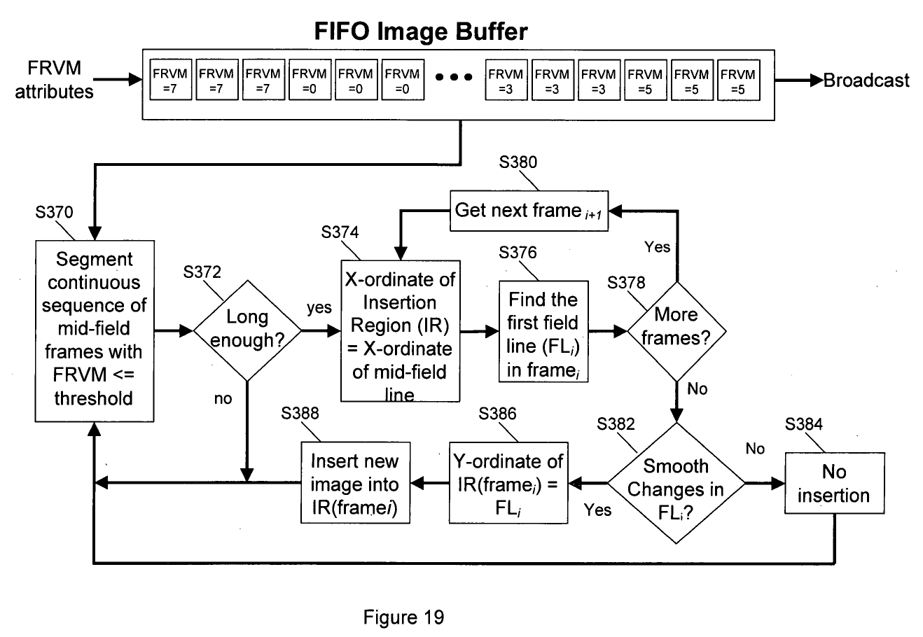

FIG. 19 is a flowchart illustrating an exemplary process used for dynamic insertion in mid-field frames. This process works in tandem with the FRVM computation of mid-field (non-exciting) play, where the x-ordinate position of the vertical mid-field line (if any) in each frame is already recorded during FRVM computation. The first field line in an image is indicative of the top-most field boundary separating the playing field from the perimeter, usually lined with advertising billboards. When an insertion decision is made, each frame within a sequence will be inserted with a dynamically located Insertion Region (IR). Henceforth, no more processing is done for this sequence. The region computation completes within 1-frame time.

Based on the updated image attributes, the frame stream is segmented into continuous sequences of mid-field frames (S370) with an FRVM below a threshold. A determination is made as to whether the current sequence is long enough for content insertion (e.g. at least around two seconds) (step S372). If the sequence is not long enough, the next sequence is selected at step S370. If the sequence is long enough, then for each frame, the X-ordinate of the mid-field line becomes the X-ordinate of the Insertion Region (IR) (step S374). For current frame i, the first field line (FLᵢ) is found (step S376). The determination of the X-ordinate of the IR and the first field line (FLᵢ) is completed for each frame of the sequence (steps S378, S380). A determination is made as to whether the change in field line position from frame to frame is smooth, that is that there is not a big FL variance (step S382). If the change is not smooth (there is a big variance), there is no insertion into the current sequence based on mid-field play dynamic insertion (step S384). If any change is smooth (the variance is not big), then for each frame i the Y-ordinate of IR becomes the FLᵢ (step S386). The relevant image is then inserted into the IR of the frame (step S388).

Step S372, determining if the sequence is long enough is not necessary where the frames are only given the attribute of mid-field play frames if the sequence is long enough, as happens in the process illustrated in FIG. 13. Such a step is also unnecessary elsewhere where the values or attributes of the frames or shot are based on a minimum sequence length that is suitable for insertion.

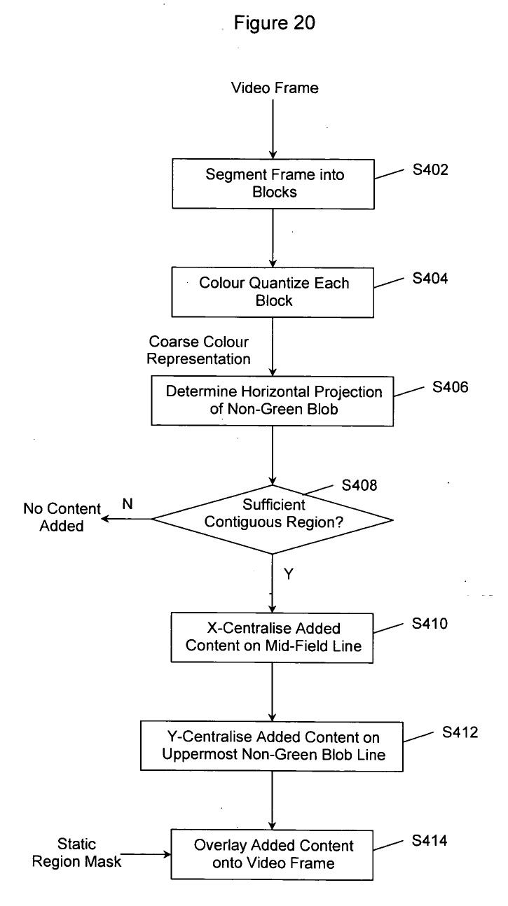

FIG. 20 is a flowchart illustrating steps involved in performing content insertion according to an alternative embodiment. A reduced resolution image is first obtained from a frame by sub-sampling an entire video frame into a number of non-overlapping blocks (step S402), for example 32×32 such blocks. The colour distribution within each block is then examined to quantize it, in this example into either a green block or a non-green block (step S404). The colour threshold used is obtained from the parameter data set (mentioned earlier). After each block is colour-quantized into green/non-green, this forms a type of coarse colour representation (CCR) of the dominant colour present in the original video frame. This is the same process of obtaining coarse colour representation (CCR) as is described with reference to FIG. 11. These initial steps segment the frame into homogenous regions of green and non-green (step S406). A horizontal projection of each contiguous non-green blob is determined (step S408) and a determination made (step S410) as to whether there is a sufficient contiguous chunk of non-green, both in height and width, for content insertion. If there is no such contiguous chunk of non-green, then the content insertion step for this video segment does not occur and the system awaits the next video segment for which it is decided that insertion might occur. If there is a sufficiently sized contiguous chunk of non-green, then content insertion occurs in that chunk.

In the embodiment of FIG. 20, assuming the frame is already known to be a mid-field view, the content is not just inserted at a random position within the appropriate target region, but at a position that follows the field centre line, whilst the centre line is in view. Thus, using the central vertical field line as a guide, the virtual content is centralised both width-wise in the X direction (step S412) and height-wise in the Y direction (step S414) in the top-most non-green blob. The insertion overlays the desired image onto the video frame (step S416). This insertion also takes into consideration the static image regions in the video frame. Using a static region mask (for example as generated by the process described with reference to FIG. 18), the system knows the pixel locations corresponding to the stationary image regions in the video frame. The original pixels at these locations will not be overwritten by the corresponding pixels in the inserted image. The net result is that the virtual content appears to be “behind” the stationary images, and therefore appears less like a late-added insertion. This might therefore appear as if the spectators in the stand are flashing a text banner.

In the flowchart of FIG. 20, content is inserted over the crowd area in a mid-field view. Alternatively or additionally the system may insert an image over a static region, whether mid-field or otherwise. Based on the determination of static regions, for instance as described with reference to FIG. 18, potential insertion positions are determined. Based on the aspect ratios of the static regions, compared with that or those of the intended image insert(s), one of the static regions is selected. The size of the selected static region is calculated and the insert image is resized to fit onto that region. The insert image is overlaid onto the selected static region, with a size that entirely overlays that region. For example a different logo may be overlaid onto the TV logo. The overlay over the static region may be a temporary overlay or one that lasts throughout the video presentation. Further, this overlay may be combined with an overlay elsewhere, for instance an overlay over the crowd. As the mid-field dynamic overlay moves, it would appear to pass behind the overlaid insert over the static region.

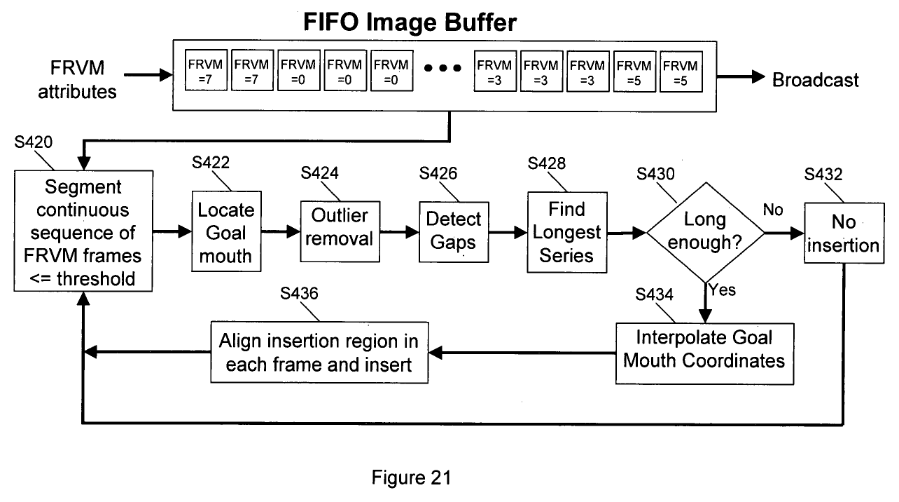

FIG. 21 is a flowchart illustrating region computation for dynamic insertion around the goal mouth. The goal mouth co-ordinates are localised, and the image inserted on top. The alignment is such that as the goal mouth moves (as a result of the camera movement), the insertion image moves with the goal mouth and appears to be a physical fixture at the scene.

The frame stream is segmented (step S420) into continuous sequences of frames with an FRVM below a certain threshold, each sequence being no longer than the buffer length. Within these frames the goal mouth is detected (step S422) (based on field/non-field determination, line determination etc.). If there is any frame where the detected position of the goal mouth appears to have jumped relative to its position in the surrounding frames around, this suggests an aberration and is termed an “outlier”. Such outlier frames are treated as if the goal mouth was not detected within them and those detected positions removed from the list of positions (step S424). Within the current sequence, gaps separating series of frames showing the goal mouth are detected (step S426), a gap, for example, being 3 or more frames where the goal mouth is not detected (or treated as not having been detected). Of the two or more series of frames separated by a detected gap, the longest series of frames showing the goal mouth is found (step S428) and a determination is made of whether this longest series is long enough for insertion (e.g. at least around 2 seconds long) (step S430). If the sequence is not long enough, the whole current sequence is abandoned for the purposes of goal mouth insertion (step S432). However, if that series is long enough, interpolation of the co-ordinates of the goal mouth is performed for any frames in that series where the goal mouth was not detected (or was detected but treated otherwise) (step S434). An Insertion Region is generated, the base of which is aligned with the top of the detected goal mouth, and the insert is inserted in this (moving) region of the image for every frame of the longest series (step S436).

The exemplary processes described with reference to FIGS. 16, 17, 19 and 21 all relate to insertion based on the FRVM. Clearly, various of the procedures relating to insertion of material could end up with the same frame undergoing various insertions or with conflicts over a frame for alternative insertions. There is therefore an order of precedence associated with types of insertion, with some combinations being allowed and some not being allowed. The order of precedence is derived from RRVM settings. The RRVM may be fixed or modifiable by the user according to the circumstances and his experience. A flag can also be set to determine if more than one type of insertion can be allowed in a single frame. For instance, where the possibilities are between: (i) homogenous region insertion, (ii) static region insertion, (iii) mid-field dynamic insertion and (iv) goal-mouth dynamic insertion, then (ii) static region insertion might be determined first and can occur with any other type of insertion. However, the other types might be mutually exclusive, with the order of precedence being: (iii) mid-field dynamic insertion, (iv) goal-mouth dynamic insertion, (i) homogenous region insertion.

In the above description, various steps are performed in different flowcharts (e.g. computing global motion in FIGS. 9 and 12 and segmenting continuous sequences of frames with an FRVM less than or equal to a threshold in FIGS. 16 and 17). This does not mean that, in a system carrying out several of these processes, the same steps will necessarily be carried out several times. With meta data the attributes generated once can be used in other processes. Thus the global motion may be derived once and used several times. Likewise, the segmenting of sequences can occur once, with further processing happening in parallel.

The present invention can be used with multimedia communications, video editing, and interactive multimedia applications. Embodiments of the invention allow innovation in methods and apparatus for implanting content such as advertisements into selected frame-sequences of a video presentation. Usually the insert will be an advertisement. However, it may be other material if desired, for instance news headlines or some such.

The above described system can be used to perform virtual advertisement implantation in a realistic way in order not to disrupt the viewing experience or to disrupt it only minimally. For instance, the implanted advertisement should not obstruct the view of the player possessing the ball during a football match.

Embodiments of the invention are able to implant advertisements into a scene in a fashion that still provides a reasonably realistic view to the end viewers, so that the advertisements may be seen as appearing to be part of the scene. Once the target regions for implant are selected, the advertisements may be selectively chosen for insertion. Audiences watching the same video broadcast in different geographical regions may then see different advertisements, advertising businesses and products that relevant to the local context.

Embodiments include an automatic system for insertion of content into a video presentation. Machine learning methods are used to identify suitable frames and regions of a video presentation for implantation automatically, and to select and insert virtual content into the identified frames and regions of a video presentation automatically. The identification of suitable frames and regions of a video presentation for implantation may include the steps of: segmenting video presentation into frames or video segments; determining and calculating distinctive features such as colour, texture, shape and motion, etc. for each frame or video segment; and identifying the frames and regions for implantation by comparing calculated feature parameters obtained from the learning process. The parameters may be obtained from an off-line learning process, including the steps of: collecting training data from similar video presentations (from video presentations recorded using a similar setting); extracting features from these training samples; and determining parameters by applying learning algorithms such as Hidden Markov Model, Neural Network, and Support Vector Machine, etc. to the training data.

Once relevant frames and regions have been identified, geometric information about the regions, and the content insertion time duration are used to determine the most appropriate type of content insertion. The inserted content could be an animation, static graphic logo, a text caption, a video insert, etc.

Content-based analysis of the video presentation is used to segment portions within the video presentations that are of lesser relevance to the thematic progress of the video. Such portions can be temporal segments, corresponding to a particular frame or scene and/or such portions can be spatial regions within a video frame itself.

Scenes of lesser relevance within a video can be selected. This provides flexibility in assigning target regions in the video presentation for content insertion. Embodiments of the invention can be fully automatic and run in a real-time fashion, and hence are applicable to both video-on-demand and broadcast applications. Whilst the invention may be best-suited to live broadcasts, it can also be used for recorded broadcasts.

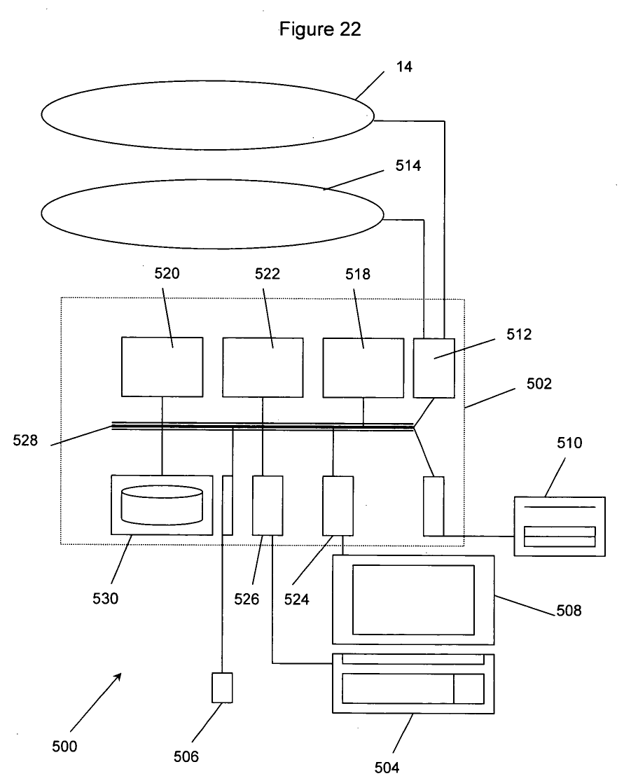

The method and system of the example embodiment can be implemented on a computer system 500, schematically shown in FIG. 22. It is likely to be implemented as software, such as a computer program being executed within the computer system 500, and instructing the computer system 500 to conduct the method of the example embodiment.

The computer system 500 comprises a computer module 502, input modules such as a keyboard 504 and mouse 506 and a plurality of output devices such as a display 508, and printer 510.

The computer module 502 is connected to the feed from the broadcast studio 14 via a suitable line, such as an ISDN line, and a transceiver device 512. The transceiver 512 also connects the computer to local broadcasting apparatus 514 (whether a transmitter and/or the Internet or a LAN) to output the integrated signal.

The computer module 502 in the example includes a processor 518, a Random Access Memory (RAM) 520 and a Read Only Memory (ROM) 522 containing the parameters and the inserts. The computer module 502 also includes a number of Input/Output (I/O) interfaces, for example I/O interface 524 to the display 508, and I/O interface 526 to the keyboard 504.

The components of the computer module 502 typically communicate via and interconnected bus 528 and in a manner known to the person skilled in the relevant art.

The application program is typically supplied to the user of the computer system 500 encoded on a data storage medium such as a CD-ROM or floppy disk and read utilising a corresponding data storage medium drive of a data storage device 550, or may be provided over a network. The application program is read and controlled in its execution by the processor 518. Intermediate storage of program data may be accomplished using the RAM 520.

In the foregoing manner, a method and apparatus for insertion of additional content into video are disclosed. Only several embodiments are described. However, it will be apparent to one skilled in the art in view of this disclosure that numerous changes and/or modifications may be made without departing from the scope of the invention.

1. A method of inserting additional content into a video segment of a video stream, the video segment comprising a series of video frames, the method comprising:
receiving the video segment;
determining the frame content of at least one frame of the video segment;
determining the suitability of the frame for insertion of additional content, based on the determined frame content; and
inserting the additional content into the frames of the video segment depending on the determined suitability.

2. A method according to claim 1, wherein
determining the suitability of the frame for insertion comprises determining at least one first measure for the at least one frame indicative of the suitability of the frame for insertion of the additional content; and
inserting the additional content depends on the determined at least one first measure.

3. A method according to claim 2, wherein the at least one first measure relative to the determined frame content is operator definable.

4. A method according to claim 2 or 3, wherein the at least one first measure indicative of the suitability of insertion of the additional content comprises a measure of the suitability of the frame for insertion of the additional content therein.

5. A method according to any one of claims 2 to 4, wherein the frame is determined to be suitable for insertion therein of additional content if the first measure is on a first side of a first threshold.

6. A method according to claim 5, wherein the frame is determined not to be suitable for insertion therein of additional content if the first measure is on a second side of the first threshold.

7. A method according to claim 1, further comprising:
determining the presence of at least one predetermined type of spatial region within the frames of the video segment; and
inserting the additional content into the video frames at a position depending on the predetermined type of spatial region determined to be present.

8. A method according to claim 7, wherein the presence of a predetermined type of spatial region is determined based on the determined frame content of at least one frame of the video segment.

9. A method according to claim 1, wherein the suitability of the frame for insertion is determined based on decision of the relevance of the frame to viewers.

10. A method according to claim 2, wherein the suitability of the frame for insertion is determined based on decision of the relevance of the frame to viewers; and
wherein the at least one first measure comprises a first relevance-to-viewer measure, of the at least one frame.

11. A method according to claim 10, wherein the first relevance-to-viewer measure is an output derived from a table, with the frame content as an input to the table.

12. A method according to claim 1, further comprising determining how exciting the video segment is, and determining the suitability of the frame for insertion of additional content, is further based on how exciting the frame is determined to be.

13. A method according to claim 12 further comprising determining the suitability of the frame for insertion comprises determining at least one first measure for the at least one frame indicative of the suitability of the frame for insertion of the additional content; and
inserting the additional content depends on the determined at least one first measure;
wherein the first relevance-to-viewer measure is derived from the frame content and from the determination as to how exciting the video segment is.

14. A method according to claim 13 wherein the first relevance-to-viewer measure is an output derived from a table, with the frame content as an input to the table;
and wherein the determination as to how exciting the video segment is comprises a further input to the table.

15. A method according to claim 12, wherein determining how exciting the video segment is comprises tracking the content of preceding video segments within the video stream.

16. A method according to claim 12, wherein determining how exciting the video segment is comprises analysing audio associated with the video segment.

17. A method according to claim 12, wherein determining how exciting the video segment is comprises analysing audio associated with preceding video segments within the video stream.

18. A method according to claim 1 further comprising pre-learning a plurality of parameters by analysing video segments of the same subject matter as the current video segment and using the pre-learned parameters to determine the suitability of the frame for insertion of additional content.

19. A method according to claim 18, wherein the pre-learned parameters are used to determine the at least one first measure.

20. A method according to claim 7, further comprising pre-learning a plurality of parameters by analysing video segments of the same subject matter as the current video segment and using the pre-learned parameters to determine the presence of the at least one predetermined type of spatial region.

21. A method according to any one of claims 18 to 20, further comprising modifying the use of the parameters based on an earlier portion of the video stream, preceding the current video segment.

22. A method according to claim 21, wherein determining the frame content of at least one frame of the video segment and determining the frame insertion suitability comprises performing content-based analysis of the video and the modified parameters to identify suitable frames and regions in the video segment for additional content insertion.

23. A method according to claim 1 further comprising selecting the additional content to be inserted prior to inserting the additional content.

24. A method according to claim 23, wherein selecting the additional content to be inserted is based on the size and/or the aspect ratio of the spatial region into which the additional content is to be inserted.

25. A method according to claim 1 further comprising detecting static spatial regions within the video stream and inserting further content into the detected static spatial regions.

26. A method according to claim 25, wherein if the further content inserted into the detected static spatial regions and the additional content overlap, the further content occludes the overlapping portion of the additional content.

27. A method of inserting further content into a video segment of a video stream, the video segment comprising a series of video frames, the method comprising:
receiving the video stream;
detecting static spatial regions within the video stream; and
inserting the further content into the detected static spatial regions.

28. A method according to any one of claims 25 to 27, wherein detecting static spatial regions comprises sampling and averaging pixel properties of a sequence of frames in the video stream to determine if pixels are stationary in the sequence of frames.

29. A method according to claim 28, wherein averaging comprises generating a time-lagged moving average.

30. A method according to any one of claims 25 to 27, wherein detecting static spatial regions comprises:
sampling pixel properties at image co-ordinates of a sequence of frames of the video stream in a time-lag window, the pixel properties comprising directional edge strength and pixel RGB intensity;
moving-average filtering the pixel properties at the same co-ordinates between frames to provide a change deviation over the time-lag window;
comparing the change deviation for different co-ordinates against a pre-defined threshold to determine if the pixels at the co-ordinates are stationary; and
determining regions of pixels so determined to be stationary.

31. A method according to claim 27, wherein determining the frame content comprises:
determining one or more dominant colours in the frame;
determining the size of interconnected regions of the same colour for one or more of the dominant colours in the frame; and
comparing the determined size against a relevant predetermined threshold

32. A method according to claim 31, wherein determining one or more dominant colours in the frame comprises classifying areas as green or non-green and comparing the determined size of the largest interconnected green area against a relevant predetermined threshold determines if the frame is of a field view.

33. A method according to claim 27, wherein the video stream is a live broadcast.

34. A method according to claim 27, wherein the video stream is a broadcast of a game.

35. A method according to claim 34, wherein the game is a game of association football.

36. A method according to claim 27, further comprising transmitting the video stream with the additional content therein to viewers.

37. Video integration apparatus operable according to the method of claim 27.

38. Video integration apparatus for inserting additional content into a video segment of a video stream, the video segment comprising a series of video frames, the apparatus comprising:
means for receiving the video segment;
means for determining the frame content of at least one frame of the video segment;
means for determining the suitability of the at least one frame for insertion of additional content, based on the determined frame content; and
means for inserting the additional content into the frames of the video segment depending on the determined suitability.

39. Video integration apparatus for inserting further content into a video segment of a video stream, the video segment comprising a series of video frames, the apparatus comprising:
means for receiving the video stream;
means for detecting static spatial regions within the video stream; and
means for inserting the further content into the detected static spatial regions.

40. Apparatus according to claim 38 or 39, operable according to the method of claim 1.

41. A computer program product for inserting additional content into a video segment of a video stream, the video segment comprising a series of video frames, the computer program product comprising:
a computer usable medium; and
a computer readable program code means embodied in the computer usable medium and for operating according to the method of claim 1.

42. A computer program product for inserting additional content into a video segment of a video stream, the video segment comprising a series of video frames, the computer program product comprising:
a computer usable medium; and
a computer readable program code means embodied in the computer usable medium and which, when downloaded onto a computer, renders the computer into apparatus as according to any one of claims 37 to 40.
